(19) United States
(12) Patent Application Publication
(10) Pub. No.: US 2010/0129504 A1
(43) Pub. Date: May 27, 2010

(54) NOVEL METHOD FOR PREPARING A FOOD PRODUCT

(76) Inventors: Damiet Josephina Petronella Cunera Koenders, Den Haag (NL); Hugo Streekstra, Amsterdam (NL)

Correspondence Address: NIXON & VANDERHYE, PC, 901 NORTH GLEBE ROAD, 11TH FLOOR, ARLINGTON, VA, 22203, US

(21) Appl. No.: 12/597,962

(22) PCT Filed: May 5, 2008
(86) PCT No.: PCT/EP08/55496

§ 371 Date: Oct. 28, 2009

(30) Foreign Application Priority Data
May 7, 2007 (EP) 07107636.8

(51) Int. Cl. A23L 1/217; A23L 1/015; A23L 1/216

(52) U.S. Cl. 426/241; 426/518; 426/431; 426/438; 426/637

(57) ABSTRACT

The invention relates to a novel method for preparing a sliced food product comprising a low amount of acrylamide. The food product is preferably of plant origin, such as a tuber or a vegetable, preferably the food product is potato-based. The invention also relates to the use of a short heat treatment to accelerate low temperature extraction of asparagine from an asparagine-containing sliced food intermediate.

### FIELD OF THE INVENTION

The invention relates to a novel method for preparing a food product comprising a low amount of acrylamide, more in particular a fried potato-based food product.

### BACKGROUND OF THE INVENTION

Recently, the occurrence of acrylamide in a number of heated food products was published (Tareke et al. Chem. Res. Toxicol. 13, 517-522 (2000)). Since acrylamide is considered as probably carcinogenic for animals and humans, this finding had resulted in world-wide concern. Further research revealed that considerable amounts of acrylamide are detectable in a variety of baked, fried and oven prepared common foods and it was demonstrated that the occurrence of acrylamide in food was the result of the heating process.

A pathway for the formation of acrylamide from amino acids and reducing sugars as a result of the Maillard reaction has been proposed by Mottram et al. Nature 419:448 (2002). According to this hypothesis, acrylamide may be formed during the Maillard reaction. During baking and roasting, the Maillard reaction is mainly responsible for the color, smell and taste. A reaction associated with the Maillard is the Strecker degradation of amino acids and a pathway to acrylamide was proposed. The formation of acrylamide became detectable when the temperature exceeded 120° C., and the highest formation rate was observed at around 170° C. When asparagine and glucose were present, the highest levels of acrylamide could be observed, while glutamine and aspartic acid only resulted in trace quantities.

The official migration limit in the EU for acrylamide migrating into food from food contact plastics is set at 10 ppb (10 micrograms per kilogram). Although no official limit is yet set for acrylamide that forms during cooking, the fact that a lot of products exceed this value, especially cereals, bread products and potato or corn based products, causes concern.

Several plant raw materials are known to contain substantial levels of asparagine. In potatoes asparagine is the dominant free amino acid (940 mg/kg, corresponding with 40% of the total amino-acid content) and in wheat flour asparagine is present as a level of about 167 mg/kg, corresponding with 14% of the total free amino acids pool (Belitz and Grosch in Food Chemistry—Springer New York, 1999). The fact that acrylamide is formed mainly from asparagine (combined with reducing sugars) may explain the high levels acrylamide in fried, oven-cooked or roasted plant products. Therefore, in the interest of public health, there is an urgent need for food products that have substantially lower levels of acrylamide or, preferably, are devoid of it.

A variety of solutions to decrease the acrylamide content has been proposed, either by altering processing variables, e.g. temperature or duration of the heating step, or by chemically or enzymatically preventing the formation of acrylamide or by removing formed acrylamide.

In several patent applications the use of asparaginase for decreasing the level of asparagine and thereby the amount of acrylamide formed has been disclosed. Suitable asparaginases for this purpose have been yielded from several fungal sources, as for example Aspergillus niger WO2004/030468 and Aspergillus oryzae WO04/032648.

For this enzyme to be effective in the food intermediate itself, the enzyme needs to be able to enter the matrix of the food intermediate. This is no problem for applications which are wet and wherein a dough, e.g. potato dough for extruded chips, or wheat dough for production of bread. Up until now, however, no good solution has been found for the reduction of acrylamide in potato crisps (also known as potato chips, thin fried potato slices). Potato crisps are in general only between 0.5 and 4 mm thick. This geometry is very suitable for the extraction of the asparagine from the potato matrix. Preferably, such extraction is performed at a low temperature in an edible solvent, such as for example water, in order to keep the structural properties of the potato slice intact. Extraction in a hot water bath for example, results in cooked potato slices, which upon frying do not result in the desired potato crisp structure and could suffer from increased oil uptake during frying. However, in case extraction is performed at low temperature, almost no asparagine leaches out of the potato matrix in a relatively short amount of time.

Low temperature extraction would therefore be a lengthy process. Grob et al (in Grob K., Biedermann M, Biedermann-Brem S., Noti A., Imhof D., Amrein T., Pfefferle A., Bazzocco, D. “Eur. Food Res. Technol.”, 2003, 217:185-194) describes extraction of asparagine from potato slices using water at different temperatures. This document shows that extraction of potato slices with cold water or with water at 45° C. for 15 minutes only reduces asparagine in the potato product of 10-14%. On the other end extraction in hot water at 80-100° C. for 2 minutes even though causing a reduction of asparagine, leads to potato products which after frying lack the desired crispiness and they are expected to have a high oil content.

It is therefore an object of the present invention, to provide a novel production process of potato chips, having reduced levels of acrylamide, whilst maintaining the structural properties of the potato slices, in order to obtain qualitatively good potato chips.

### DESCRIPTION OF THE INVENTION

Surprisingly, it has been found that use of a short heat treatment dramatically accelerates low temperature extraction of asparagine from an asparagine-containing food intermediate. This for the first time in the art enables an efficient extraction of asparagine from an asparagine-containing food intermediate, for example potato slices, whilst still maintaining the right structural properties to produce the food product in a good quality, for example potato chips, because of the short time the heat treatment is given.

Therefore in one aspect the invention provides the use of a short heat treatment to accelerate low temperature extraction of asparagine from an asparagine-containing food intermediate.

Short is herein intended to mean at most 90 seconds, preferably between 30 and 90 seconds, more preferably between 45 and 75 seconds and most preferably between 50 and 70 seconds. Preferably, the heat treatment is performed at a temperature of at least 60° C., more preferably at least 70° C., more preferably at least 75° C. and most preferably at least 80° C. Preferably, the heat treatment is performed at a temperature of at most 100° C., more preferably at most 95° C., even more preferably at most 90° C. and most preferably at most 85° C. The heat treatment is preferably performed under atmospheric pressure. In case the heat treatment is performed at above atmospheric pressure, then also higher heating temperatures and heating times even shorter than 30 seconds may be used. In case the heat treatment is performed at a pressure above atmospheric pressure, the heating temperature is preferably at most 120° C. Preferably, the higher the temperature, the shorter the heat treatment. For example, in case the heating temperature used is 120° C., the heat treatment can be as short as 10 seconds, if the temperature used is ±100° C., the heat treatment is preferably applied for between 30 and 40 seconds, in case the temperature is 95° C. the heat treatment is preferably applied for between 30 and 45 seconds, in case the temperature is 90° C. the heat treatment is applied for 30 and 50 seconds, in case the temperature is 85° C. the heat treatment is applied for 30 and 55 seconds. In case the temperature used during the heat treatment is 80° C., the heat treatment is preferably applied for between 30 and 60 seconds, or in case the temperature used during the heat treatment is 60° C., the heat treatment is preferably applied for between 45 and 74 seconds. The duration of the heat treatment can be optimised by the person skilled in the art, upon visual inspection of the food intermediate after the heat treatment to determine the state of the structure of the food intermediate.

Low temperature extraction is intended to mean an extraction process considerably lower than the temperature of gelatinization of the starch in the asparagine-containing food intermediate, preferably at most 50° C., more preferably at most 45° C. and even more preferably at most 40° C., most preferably at most 35° C. Preferably, the temperature of extraction is above the freezing point of the extraction solvent used. More preferably the temperature of extraction is above 15° C., more preferably above 20° C., even more preferably above 25° C. and most preferably about 30° C.

Efforts to open the potato matrix by blanching optionally followed by extraction of asparagine out of the matrix, are for example disclosed in US2004/0101607, wherein potato slices are blanched shortly followed by a lengthy extraction process, involving heating up the potato slices in a microwave and refreshing the extraction fluid several times. The extraction method used in the examples is very labourious and also results in a loss of structural properties of the potato slices which is unacceptable for the crisps-producing industry. In US2004/0101607 no indication was given that the extraction should preferably take place at such a low temperature, nor that it could be so short as found in the present invention in order to be effective. The problem of maintaining good structural properties, especially for sliced food intermediates was not mentioned.

In another aspect the invention provides a method of producing a food product comprising the step of:
a. heating an asparagine-containing food intermediate to a temperature of at least 60° C. for between 30 and 90 seconds (short heat treatment);
b. extracting at least part of the asparagine at a temperature between 0 and 50° C. for between 5 and 35 minutes from the food intermediate (cold extraction);
c. heating the food intermediate to a temperature above 100° C., preferably above 120° C. to yield a food product.

A food intermediate of the food product is defined herein as any form of the asparagine-containing food product that occurs during the production process. Preferably, the food intermediate already has the shape and size of the food product that is subjected to the heating step(s). In another sense, it is characteristic of the food intermediate of the food product that its surface areas are substantially the same as the surface areas of the form of the food product that is subjected to the heating step(s), although it is admissible that additional surface areas are formed after the extraction treatment, for instance by cutting, as long as the new surface area constitutes a relatively minor fraction of the total surface are, preferably less than 20% of the total area, more preferably less than 15% of the total area and most preferably less than 10% of the total area. The food intermediate does not necessarily comprise all the individual raw materials and/or additives and/or processing aids. For example, for the food product French fries, the food intermediate comprise the raw cut potato slices, the cooked potato slices, and the potato slices after a first industrial frying step (but before subsequent frying steps). Whether, when, or where other components, such as seasonings, flavorings, or other additives, are added, is not relevant with respect to the present invention.

The food product may be made from at least one asparagine-containing raw material, for example of plant origin. Preferably the food intermediate or food product is a food of plant origin, rich in asparagine and which may undergo slicing and a heating step at a temperature above 100° C. during its preparation, typically said heating step may comprise frying or baking. Examples of preferred food products are, for example tubers such as potato (also including sweet potato), Chinese potato, Japanese potato, arrowhead, topinambour, tapioca root, ling gaw, cassava (including sweet cassava); Jerusalem artichoke, jicama, aspargus, celeriac, onion, carrot, other vegetables such as egg plant, zucchini, broccoli, coulyflower, pumpkin. Other examples of food products are legumes, such as, peas or soy beans; aromatic plants, such as tobacco, coffee or cocoa; nuts; or cereals, such as wheat, rye, corn, maize, barley, groats, buckwheat, rice, or oats. Also food products made from more than one raw material are included in the scope of this invention, for example food products comprising both corn and potato. In a preferred embodiment of the invention, the food intermediate is of plant origin, more preferably a tuber or a vegetable, most preferably the food intermediate is potato-based.

The invention is especially suitable for potato-based food products comprised of a macroscopic fraction of potato, for example peeled or cut potato such as potato slices. The potato-based food intermediate is for example suitable for production of French fries or potato chips.

The present invention is especially suitable for sliced food products. Preferably the food intermediate comprises slices, preferably of between 0.5 and 4.0 mm of the food raw material, more preferably of between 0.5 and 3.0 mm, even more preferably between 1.0 and 2.5 mm, most preferably between about 1.0 and 1.5 mm.

The heating step a. can be performed in several ways. In one embodiment, the food intermediate is heated by for example an oven, grill or microwave.

In another embodiment of the invention, the heating step a. is performed by inserting the food intermediate in a liquid, e.g. a liquid bath of between 60 and 100° C.

Preferably, the liquid has a temperature of at least 60° C., more preferably at least 70° C., more preferably at least 75° C. and most preferably at least 80° C. Preferably, the liquid has a temperature of at most 100° C., more preferably at most 95° C., even more preferably at most 90° C. and most preferably at most 85° C.

Preferably the liquid is an edible liquid, and more preferably the liquid is water. To the liquid bath also other compounds can be added, for example, chemical treatment agents—such as for example pyrophosphate or other salts.

Extraction is defined in the present invention as any means of contacting the food intermediate with a solvent such that at least part of the asparagine is removed from the food intermediate. Any solvent in which asparagine is soluble can be used, preferably an edible solvent is used, most preferably the solvent is water.

The extraction can comprise methods such as soaking, leaching, washing, rinsing or combinations thereof. What is most important is that the extraction process is not performed at a temperature higher than the temperature at which starch gelatinizes, i.e. at most 50° C., more preferably at most 45° C., even more preferably at most 40° C., and most preferably at most 35° C. Preferably, the temperature of extraction is above the freezing point of the extraction solvent used. More preferably the temperature of extraction is above 15° C., more preferably above 20° C., even more preferably above 25° C. and most preferably about 30° C. Preferably, the extraction takes place by transporting it through or keeping the food intermediate for a certain amount of time in a liquid bath. The amount of time for the extraction bath is for processing purposes preferably as short as possible. According to one embodiment of the invention extraction of at least 5 minutes already leads to a considerable decrease of the amount of asparagine in the food intermediate, and thus a decrease of the amount of acrylamide in the end food product.

The extraction is preferably as short as possible, since this is more convenient for industrial purposes. Typically the extraction will take at most 35 minutes, preferably at most 30 minutes, more preferably at most 20 minutes and most preferably at most 15 minutes. In an optimised version of the process according to the invention even an extraction of 5 minutes showed good reduction of the amount of asparagine in the food intermediate.

In case an extraction liquid bath is used, to the extraction liquid bath also other compounds can be added, for example, anti-microbial agents—such as for example benzoic acid—or chemical treatment agents—such as for example pyrophosphate or other salts.

In a preferred embodiment of the invention, the extracted asparagine is effectively removed from the extraction solvent (liquid bath), preferably during the extraction. This has as an advantage that the extraction of the asparagine from the food intermediate is further accelerated. There are several means available for removing asparagine from the extraction solvent (liquid bath), for example by using asparaginase, an enzyme that can degrade asparagine, in the solution. Therefore in one embodiment of the invention the liquid bath comprises asparaginase. Examples of suitable asparaginases for this purpose have been yielded from several fungal sources, as for example Aspergillus niger WO2004/030468 and Aspergillus oryzae WO04/032648.

In one embodiment of the invention, the food intermediate is heated in step c. by frying it in oil. Alternatively, the food intermediate is heated in step c. by baking it in an oven or microwave.

The food intermediate to which the process according to the invention is applied to does not have to be subjected to the cold extraction step b. directly following the short heat treatment of step a. —at least one additional processing step may take place between heat treatment step a. and extraction step b. Examples of such processing steps are drying, equilibrating (resting), coating, cooling, soaking, chemical treatment or combinations of any of them. A chemical treatment can for example be the use of pyrophosphate or other salts.

The food intermediate to which the process according to the invention is applied to does not have to be subjected to the heating step c. directly following step b. —at least one additional processing step may take place between extraction step b. and heating step c. Examples of such processing steps are drying, equilibrating (resting), coating, cooling, heating, soaking, chemical treatment or combinations of any of them. A chemical treatment can for example be the use of pyrophosphate or other salts.

In a further aspect, the invention relates to a food product obtainable by the use and method according to the invention. Especially potato chips having low acrylamide content, but maintaining their structural properties have not been produced in the art.

Preferred embodiments of one aspect of the invention are equally applicable to other aspects of the invention.

Hereafter some examples are presented to illustrate the invention which however should not be interpreted as to be limiting.

### EXAMPLES

### Comparative Experiment A

### The Effect of the Water Temperature on the Extraction of Potato Slices

### Experimental Set-Up

From the central section of the potatoes, 1.5 mm thick slices were cut and punched with a diameter of 26 mm. For each treatment regime 20 slices were pooled, and treated as one sample. After the treatment, the slices were rinsed, dried, weighed, homogenized with a known amount of liquid, and analyzed by HPLC.

The samples were extracted for 30 minutes in water of various temperatures. The amount of potato in each extraction was about 17 g, and the amount of extraction liquid (water) was 500 g.

### Results

The reference (not extracted potato) had the following levels of amino acids: aspartate: 0.42, glutamate: 0.62, asparagine: 3.74, and glutamine: 2.08 g/kg. These values were set to 100%, and the levels of amino acids after the various treatments was calculated relative to these reference levels.

| | ASP | GLU | ASN | GLN |
|---|---|---|---|---|
| Temperature | (g/kg) | (g/kg) | (g/kg) | (g/kg) |
| Blank | 100 | 100 | 100 | 100 |
| 40 | 60 | 44 | 64 | 72 |
| 50 | 33 | 32 | 45 | 50 |
| 55 | 19 | 11 | 21 | 23 |
| 60 | 17 | 13 | 18 | 20 |
| 65 | 12 | 10 | 12 | 13 |
| 70 | 17 | 15 | 16 | 18 |
| 80 | 12 | 11 | 11 | 12 |

It is clear that efficient extraction of amino acids only occurs at temperatures of at least 55° C., even with this relatively lengthy extraction procedure, and using a large volume of fresh water (initially free of the substances to be extracted).

The combination of the long extraction time and the high temperature led to clearly observable changes in the texture of the potato slices, changing from a raw towards a more cooked appearance.

### Example 1

### The Effect of a Short Heat Treatment Upon Subsequent Extraction of Amino Acids from Intact Potato Matrix

### Experimental Set-Up

From the central section of the potatoes, 1.5 mm thick slices were cut and punched with a diameter of 26 mm. For each treatment regime 20 slices were pooled, and treated as one sample. After the treatment, the slices were rinsed, dried, weighed, homogenized with a known amount of liquid, and analyzed by HPLC.

The samples were heat treated for various periods in water at a temperature of 80° C. The volume of the water was 250 ml.

Half of the material was measured directly after the heat treatment—the other half was subjected to 30 minutes of leaching in 250 ml of 0.5% Na-pyrophosphate (pH=5) at 30° C.

### Results

The raw (not heat-treated and not leached) potato had the following levels of amino acids: aspartate: 0.49, glutamate: 0.45, asparagine: 2.74, and glutamine: 2.14 g/kg. These values were set to 100%, and the levels of amino acids after the various treatments was calculated relative to these reference levels.

| | Heat Treatment | Leaching | ASP | GLU | ASN | GLN | ASP + ASN |
|---|---|---|---|---|---|---|---|
| Sample | (minutes) | (minutes) | (g/kg) | (g/kg) | (g/kg) | (g/kg) | (g/kg) |
| 1 | 0 | 0 | 100 | 100 | 100 | 100 | 100 |
| 2 | 1 | 0 | 65 | 67 | 71 | 72 | 70 |
| 3 | 3 | 0 | 55 | 58 | 57 | 60 | 57 |
| 4 | 6 | 0 | 41 | 42 | 46 | 46 | 45 |
| 5 | 9 | 0 | 37 | 40 | 43 | 42 | 42 |
| 1L | 0 | 30 | 63 | 76 | 86 | 91 | 83 |
| 2L | 1 | 30 | 18 | 18 | 18 | 19 | 18 |
| 3L | 3 | 30 | 14 | 18 | 17 | 19 | 16 |
| 4L | 6 | 30 | 12 | 13 | 13 | 15 | 13 |
| 5L | 9 | 30 | 10 | 11 | 10 | 12 | 10 |

It is clear that even the shortest heat treatment (of 1 minute) gave a significant improvement of the amino acid extraction in the subsequent leaching step. In fact, the further reduction of potato amino acid levels observed after leaching in the samples that were heat treated longer, is completely explained by the lower amino acid levels obtained during the longer heat treatment procedure itself. In other words, the subsequent leaching step was already fully efficient after 1 minute of heat treatment. This effect was independent on the nature or the absolute level of the amino acid.

### Example 2

### Further Exploration of Heat Treatment Time

From the central section of the potatoes (Saturna), 1.4 mm thick slices were cut with a food slicer and punched with a diameter of 26 mm. For each treatment regime 24 slices were pooled, and treated as one sample. The samples were heat treated for various periods (0, 15, 30, 45, 60, 120, 180 sec) in 150 ml water at a temperature of 80° C. After heat treatment, the slices were cooled and rinsed in cold water. Half of the material was dried, weighed, homogenized with 250 ml 0.1M HCL, and analyzed by HPLC. The other half was subjected to 30 minutes of leaching in 150 ml of 0.5% Na-pyrophosphate (pH=5) at 30° C. After the treatment, the slices were rinsed with water, dried, weighed, homogenized with 250 ml 0.1M HCl, and analyzed by HPLC.

| Heat | Cold | | | | |
|---|---|---|---|---|---|
| treatment | Extraction | ASP | GLU | ASN | GLN |
| (sec) | (min) | (g/kg) | (g/kg) | (g/kg) | (g/kg) |
| 0 | 0 | 100 | 100 | 100 | 100 |
| 15 | 0 | 82 | 78 | 85 | 69 |
| 30 | 0 | 80 | 76 | 74 | 64 |
| 45 | 0 | 90 | 74 | 95 | 73 |
| 60 | 0 | 94 | 80 | 91 | 85 |
| 120 | 0 | 76 | 66 | 67 | 59 |
| 180 | 0 | 62 | 54 | 58 | 50 |
| 0 | 30 | 62 | 62 | 80 | 63 |
| 15 | 30 | 40 | 58 | 72 | 56 |
| 30 | 30 | 28 | 34 | 45 | 34 |
| 45 | 30 | 34 | 26 | 42 | 36 |
| 60 | 30 | 18 | 10 | 18 | 16 |
| 120 | 30 | 10 | 10 | 13 | 13 |
| 180 | 30 | 8 | 8 | 12 | 12 |

Again, it is clear that 1 minute of treatment at 80° C. was sufficient to allow good extraction at 30° C., and that longer heat treatments did not offer improved extraction—although the total reduction of amino acids was higher due to the higher reduction during the heat treatment procedure itself.

Heat treatment shorter than 1 minute also had a clear positive effect on the subsequent extraction rate, but did not show the full benefit of the 1 minute treatment.

It was observed that when potatoes were heat-treated substantially longer than 60 seconds at 80° C., e.g. when they were treated at 80° C. for 120 seconds, there was a clear change in appearance of the slices, having more the structure and appearance of cooked potatoes. When such slices were fried, the resulting fried product was of a lower quality, having higher oil uptake and a less crispy texture.

### Example 3

### Further Exploration of Extraction Time

From the central section of the potatoes (Saturna), 1.4 mm thick slices were cut with a food slicer and punched with a diameter of 26 mm. For each treatment regime 24 slices were pooled, and treated as one sample. The samples were heat treated for 1 minute in 150 ml water at a temperature of 80° C. After heat treatment, the slices were cooled and rinsed in cold water. Half of the material was dried, weighed, homogenized with 250 ml 0.1M HCL, and analyzed by HPLC. The other half was subjected to various periods of leaching in 150 ml of 0.5% Na-pyrophosphate (pH=5) at 30° C., in the presence or absence of 5 U/ml of asparaginase. After the treatment, the slices were rinsed with water, dried, weighed, homogenized with 250 ml 0.1M HCL, and analyzed by HPLC.

| | | ASP | | GLU | | ASN | | GLN | |
|---|---|---|---|---|---|---|---|---|---|
| Heat | Extraction | (g/kg) | | (g/kg) | | (g/kg) | | (g/kg) | |
| treatment | time | Asparaginase: | | | | | | | |
| (min) | (min) | − | + | − | + | − | + | − | + |
| 0 | 0 | 100 | | 100 | | 100 | | 100 | |
| 1 | 0 | 62 | | 56 | | 63 | | 72 | |
| 0 | 10 | 64 | 66 | 72 | 70 | 81 | 77 | 82 | 76 |
| 0 | 30 | 46 | 56 | 66 | 70 | 73 | 82 | 71 | 79 |
| 1 | 1 | 50 | 50 | 44 | 40 | 50 | 55 | 50 | 54 |
| 1 | 5 | 40 | 58 | 32 | 30 | 46 | 39 | 50 | 43 |
| 1 | 10 | 28 | 62 | 24 | 26 | 31 | 30 | 33 | 40 |
| 1 | 20 | 24 | 72 | 18 | 14 | 26 | 15 | 28 | 25 |
| 1 | 30 | 14 | 90 | 10 | 12 | 16 | 8 | 20 | 20 |

As expected, the extraction rate of amino acids was directly related to the extraction time. After 20 minutes, the residual level was 26% or less, provided that a heat treatment was performed. Without prior heat treatment, the extraction was still modest after 30 minutes. With special reference to asparagine, it was found that the presence of asparaginase improved the extraction level in those cases where the extraction was already extensive, but not at low extraction levels. These data also show that the enzyme confers a certain level of selectivity to the extraction process: whereas the extraction of asparagine was improved, this did not apply to the other amino acids.

1. Method of producing a sliced food product comprising the steps of:
a. heating an asparagine-containing food intermediate to a temperature of at least 60° C. for between 30 and 90 seconds;
b. extracting at least part of the asparagine at a temperature between 0 and 50° C. for between 5 and 35 minutes from the food intermediate;
c. heating the food intermediate to a temperature above 100° C., preferably above 120° C. to yield a food product.
wherein extracting is performed at a temperature of at most 50° C.

2. Method according to claim 1, wherein the food intermediate is of plant origin, preferably a tuber or a vegetable, more preferably the food intermediate is potato-based.

3. Method according to claim 1, wherein the food intermediate comprises slices of between 0.5 and 4.0 mm of the food raw material.

4. Method according to claim 1, wherein heating step a. is performed by inserting the food intermediate in a liquid bath of between 75° C. and 95° C.

5. Method according to claim 1 wherein the heating step a. is performed for 50 to 70 seconds.

6. Method according to claim 1 wherein the temperature of extraction in b. is at most 40° C.

7. Method according to claim 1 wherein the temperature of extraction in b. is above 20° C.

8. Method according to claim 1, wherein the food intermediate is extracted in step b. by transporting it through or keeping it in a liquid bath.

9. Method according to claim 8 wherein asparagine is removed from the liquid bath during the extraction.

10. Method according to claim 8 wherein the liquid bath comprises asparaginase.

11. Method according to claim 4 wherein the liquid is water.

12. Method according to claim 1 wherein the food intermediate is heated in step c. by frying it in oil.

13. Method according to claim 1, wherein the food intermediate is heated in step c. by baking it in an oven or microwave.

14. Use of a short heat treatment to accelerate low temperature extraction of asparagine from an asparagine-containing sliced food intermediate.

15. Use according to claim 14, wherein the food intermediate is of plant origin, preferably a tuber or a vegetable, more preferably the food intermediate is potato-based.

16. Use according to claim 14, wherein the food intermediate comprises slices of between 0.5 and 4.0 mm of the food raw material.

17. Use according to claim 14 wherein the short heat treatment is a treatment of between 30 and 90 seconds.

18. Use according to claim 14 wherein the short heat treatment is a treatment performed at a temperature of at least 75° C. and at most 95° C.

19. Use according to claim 14 wherein the low temperature extraction is of at most 40° C.

20. Use according to claim 14 wherein the low temperature extraction is above 20° C.

21. Use according to claim 14 wherein extraction takes at most 35 minutes.

22. Use according to claim 14 wherein extraction is performed by transporting the food intermediate through or keeping the food intermediate in a liquid bath.

23. Use according to claim 22 wherein the liquid bath comprises asparaginase.

24. Food product obtainable by the method according to claim 1.
